(19) United States
(12) Patent Application Publication
(10) Pub. No.: US 2004/0225616 A1
(43) Pub. Date: Nov. 11, 2004

(54) Method, system and computer program product for third-party verification of anonymous e-marketplace transactions using digital signatures

(76) Inventors: Gordon K. Arnold, Cary, NC (US); David G. Kuehr-McLaren, Apex, NC (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 10/434,877

(22) Filed: May 9, 2003

(51) Int. Cl. G06F 17/60

(52) U.S. Cl. 705/74

(57) ABSTRACT

Parties involved in a transaction in an E-marketplace can “pre-qualify” an entity that can transact business in the E-marketplace. The entity is a “persona” that is able to satisfy the needs of another party in the E-marketplace; none of the parties making up the entity can alone satisfy these needs, but together they are able to. The attributes of the parties making up the entity are verified by a third party (such as the E-marketplace) and a single attribute certificate, identifying the combined attributes of the persona, is made available to users of the E-marketplace.

### BACKGROUND OF THE INVENTION

1. Field of the Invention

The present invention relates to computer-based on-line commerce in which sellers and buyers of goods or services are linked via an electronic marketplace where deals are negotiated and consummated.

2. Description of the Related Art

As networks of linked computers become an increasingly more prevalent concept in everyday life, on-line interactions between buyers and sellers have become commonplace. Transactions between a business and an individual consumer are referred to as business-to-consumer (B2C) transactions and transactions between businesses (e.g., the sale of goods from a wholesaler to a manufacturer who uses the purchased goods to eventually sell a product on the retail level) are referred to as business-to-business (B2B) transactions.

As a result of this increased use of networked computers to transact business, the concept of the electronic marketplace, referred to herein as the “E-marketplace,” has emerged and become a standard form of conducting these business transactions. For a variety of reasons, the intermediary function provided by the E-marketplace is now an everyday part of transactional commerce.

On the consumer end, E-commerce sites such as E-Bay, half.com, Ubid.com, and AuctionPort.com provide an E-marketplace serving as a central location for negotiation of sales and/or auctions of products or services from a seller to a consumer (e.g., bidders). Likewise, B2B sellers, such as BizBuyer.com and FastParts.com, provide a similar intermediary service for business transactions between businesses.

Unlike a typical “brick-and-mortar” establishment where the buyer and seller will typically meet face-to-face and negotiate deals, and where the parties can gauge reactions by watching and listening, in an E-marketplace no such interaction occurs and, in fact, it may be desirable for the identity of the parties to the transaction to be concealed. For example, if a large company is involved in a transaction, a party seeking to transact a deal with the large corporation may attempt to charge a higher price; similarly, a large corporation may give one price to a favored business partner while not wishing to give the same favorable terms to a first-time or occasional purchaser. In either case, it may be desirable for one or both of the parties to remain anonymous. However, even when a pseudonym is used for a transaction, existing methods of concealing identifies still fall short. For example, a bidder on E-Bay can be tracked across an auction by his user ID (often a pseudonym), and the bidder must also disclose his or her email address to vendors, in order to inquire about or to purchase an item. This information (user ID, email address, etc.) is the bidder's “bid history”. Once this information is revealed, a seller can use the bidder's bid history to make contact, e.g., by sending multiple, continual emails presenting offers of items the bidder has shown interest in from past bids.

Although not limited to B2B transactions, it is common in B2B transactions to have one of the parties pre-qualify for an available credit line or provide a promise of insurance to guarantee shipping of the goods being purchased as part of the transaction. In prior art systems involving B2B transactions, a buyer A and supplier X might agree to terms for a sale as long as the performance under the contract was insured by a third party agent M. Separate agreements would have to be negotiated with agent M and the parties, or a third party server would have to be accessed (e.g., Verisign) to obtain the insurance. In either case, having a third party as part of the agreement complicates the transaction and as a result, the agreement may not be reached as time is wasted attempting to have all three parties agree to terms. Similar potential complications can arise when a third party is financing the purchase.

Verification-of-identity issues are also of concern in an E-marketplace since, unlike a face-to-face transaction, an E-marketplace transaction is essentially “faceless.” However, under current E-marketplace scenarios, the only viable options available in the prior art are total security, where everything communicated between the buyer and seller is closed to all others, or the use of “public-key encryption”, which allows the verification of identity information to protect very limited, static, encrypted information (e.g., credit card numbers), but all other information is open to the public and linkable to the public-key holder. The “total security” option prevents public negotiation and other advantages offered by a multi-vendor marketplace. Since a primary benefit of an E-Marketplace is its open nature which makes public negotiation available, security measures such as public-key certificates are typically employed in an E-marketplace environment.

As is well known, public key encryption systems involve the use of a publicly available public key in conjunction with a related private key available only to authorized persons or entities. Presentation of both keys is necessary to decrypt the information.

Attribute certificates were developed to augment public-key certificates. An attribute certificate has the same structure as a public-key certificate and is, in fact, a type of public key certificate. In addition to containing the public key of the certificate holder, however, it also contains information (attributes) about the certificate holder, and does not contain identity information. Instead, it can be linked to the public-key certificate of the holder. For example, attribute certificates have been used in the Health Care industry to identify the accreditation, certification(s) and role of a particular health care provider providing medical advice or information electronically. One of the benefits of using an attribute certificate is that unlike a public-key [an identification] certificate, which stays essentially the same all the time, attributes are dynamic and thus may,change frequently (e.g., additional certifications may be obtained, or the health care provider may have different roles depending on a situation). Attribute certificates can be issued with a limited lifetime so that they expire automatically, eliminating the administrative burden of having to continually revoke and revise certificates each time there is a change in an attribute. Applicant is unaware of any use of attribute certificates in connection with transactions in an E-marketplace or similar electronic transactional situation.

A problem exists where buyers, sellers, and/or third party participants in an E-marketplace want a private relationship for a transaction and want some assurance, before advancing too deeply into the bargaining stage, that a deal can be structured that meets their needs.

### SUMMARY OF THE INVENTION

In accordance with the present invention, parties involved in a transaction in an E-marketplace can “pre-qualify” an entity that can transact business in the E-marketplace. The entity is a “persona” that is able to satisfy the needs of another party in the E-marketplace; none of the parties making up the entity can alone satisfy these needs, but together they are able to. The attributes of the parties making up the entity are verified by a third party (such as the E-marketplace) and a single attribute certificate, identifying the combined attributes of the persona, is made available to users of the E-marketplace.

Creation of the persona is accomplished by first having each buyer, seller, and third party wishing to do business in the E-marketplace create and submit to the E-marketplace an attribute certificate that identifies what that party needs and/or can contribute to transactions occurring in the E-marketplace. Such attributes include, but are not limited to, the volume of a product needed (e.g., 10,000 units per day for 2 years), the volume of product capable of being supplied (e.g., 100,000 units per month), credit information, payment history, delivery terms, bonding information, insurance information, ratings provided by third parties (e.g., the e-Marketplace, the Better Business Bureau, etc.), required licenses (e.g., retail license, toxic chemical license, etc.), state/federal certifications, industry certification, or international certifications.

For example, a buyer may wish to purchase 10,000 widgets and, while no single seller is available in the marketplace to satisfy that request, a consortium of three sellers may be able to satisfy the request, and can agree ahead of time with a bonding agent to insure the deal. This presents to the E-marketplace a “seller” (the consortium identified by the persona) that can satisfy the demands of the buyer. A single attribute certificate is created identifying the existence of a persona that can accomplish the combined attributes of the consortium. If the buyer were to look only at the individual market participants, it would find no participant able to meet its needs and would take its business elsewhere. In accordance with the present invention, the participants in the marketplace band together, “create” a “participant” that can meet the sellers needs, and present this pre-qualified entity to the E-marketplace so that all parties benefit.

Each of the attributes are verified by a trusted authority (e.g., the E-marketplace acting as an intermediary for the transaction) so that when the attribute certificate of the persona is supplied to a party, the party is assured that the information it contains is accurate. In this manner, parties to a negotiation are able to know immediately and with a high level of assurance that certain critical elements to the proposed transaction are met (or are capable of being met). This information is made available to all participants in the bidding/negotiating process (as opposed to being available only when specifically authorized by the certificate owner) but without the need to identify the identities of the certificate owner. Since the nature of an attribute certificate is temporary, the attribute certificate can pertain only to a particular transaction and not be utilized for (or linked to) other transactions involving the same seller or consumer.

### BRIEF DESCRIPTION OF THE DRAWINGS

FIG. 1 illustrates a typical E-marketplace environment in which the present invention can be practiced; and

FIG. 2 is a flowchart illustrating the basic steps performed in accordance with the present invention.

### DETAILED DESCRIPTION OF THE PREFERRED EMBODIMENTS

The present invention utilizes “attribute certificates” to provide transactional information to an E-marketplace while allowing specific details that would otherwise identify the parties to the transaction to remain unidentified. As discussed above, attribute certificates are well-known and it is not the attribute certificate itself that is the subject of the present invention but rather a novel method of using attribute certificates in electronic transactions.

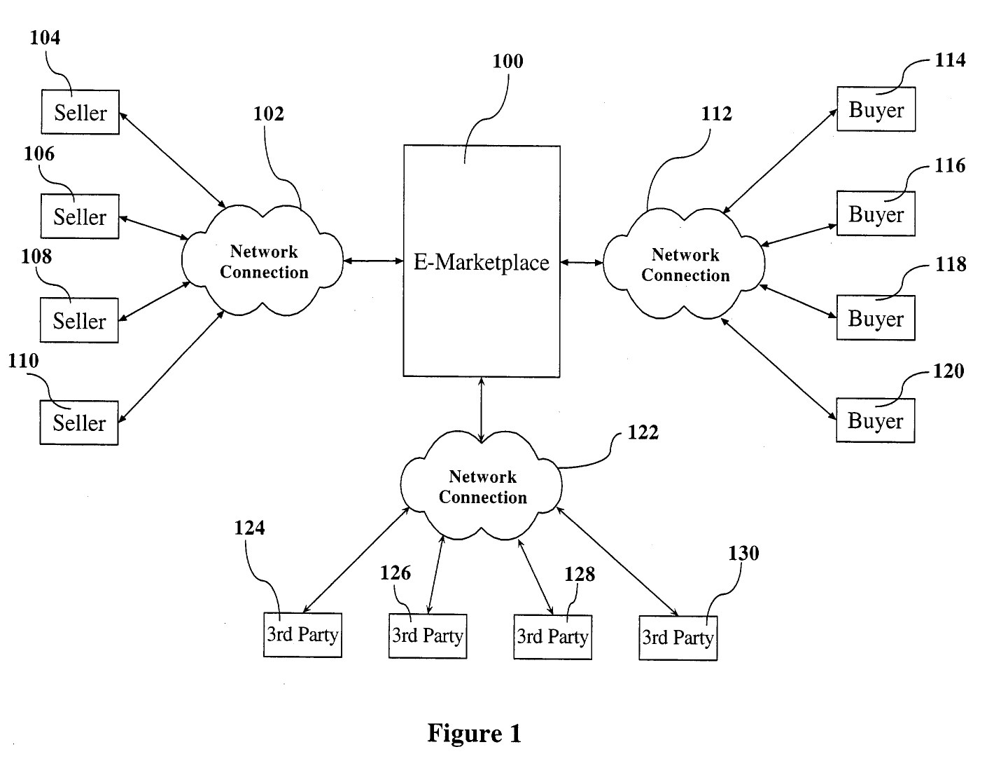

FIG. 1 illustrates a typical E-marketplace environment in which the present invention can be practiced. An E-marketplace 100 is coupled to a plurality of sellers 104, 106, 108 and 110 via a network connection 102 (e.g., the Internet). Similarly, E-marketplace 100 is connected to a plurality of buyers 114, 116, 118, and 120 via a network connection 112. In addition, E-marketplace 100 is connected to a plurality of third party participants 124, 126, 128, and 130 via a network connection 122. The third party participants may include shipping companies, packaging companies, financial institutions, insurance or bonding companies, and the like.

Typically, the E-marketplace 100 will comprise a server configured to receive communications from the network connections 102, 112, and 122 store information for viewing by parties connection to the network connections 102, 112, and 122, and other information pertaining to transactions that may occur in the E-marketplace. Sellers 104, 106, 108, and 110; buyers 114, 116, 118, and 120; and third-party participants 124, 126, 128, and 130 typically use PC workstations, networks or other known means for accessing the E-marketplace via the network connections 102, 112, and 122.

In a typical electronic transaction using the environment illustrated in FIG. 1, a seller, e.g., seller 104, will connect to E-marketplace 100 via the network connection 102 and register with the E-marketplace. Seller 104 may identify itself by pseudonym and typically will be required to provide real name, address information, e-mail address and other information for identification purposes.

Seller 104 will also provide information regarding a particular transaction, e.g., the sale of a particular IC chip, to be used by potential purchasers, as well as by the E-marketplace to attract potential purchasers.

This information might include quantities available for purchase, pricing information, delivery information, payment terms that will be accepted, and the like. Much of this information may be important to only one particular transaction, but not to another. In accordance with the present invention, this specific information pertaining to attributes of the sale are provided to the E-marketplace using an attribute certificate so that they will be available to all interested in participating in the bidding/negotiating process with respect to the transaction. The attribute certificate describes the attributes of the transaction, e.g., the products involved, but does not necessarily disclose or describe the identity of the seller. Many other sellers may provide similar information.

The same information is provided to the E-marketplace by potential buyers and by third party participants. For example, buyer 114 can provide an attribute certificate to E-marketplace 100 via network connection 112. The attribute certificate from the buyer might include desired quantities for purchase, as well as credit history, financial information, and the like. Likewise, third party participants provide attribute certificates describing the services that they can provider to users of the E-marketplace.

In a preferred embodiment, the E-marketplace 100 verifies all of the information contained in the attribute certificates. Once this information has been verified, in accordance with the present invention, sellers and third party participants can collaborate to form a persona that, as a group, is able to meet the needs of a particular seller as expressed in the seller's attribute certificate. This can be done in advance, as when the sellers and third parties are already aware of each other prior to “entering” the E-marketplace, or it can be accomplished after “meeting” in the E-marketplace, and the details of the collaboration can even be “discussed” electronically (e.g., via e-mail or chat) within the E-marketplace itself. Either way, this procedure allows these consortiums to be created without the knowledge of the potential purchasers.

The primary market served by the E-marketplace is purchasers trying to obtain desired products from sellers. A secondary market, however, is created that involves the searching among the sellers and third party participants to see if a consortium can be formed to meet the stated requirements of the buyers. If such a consortium can be established, as a group the parties have a chance to complete the transaction. A “persona attribute certificate” is created when a consortium of parties determines that as a group, they can satisfy the needs of another E-marketplace participant. The persona attribute certificate identifies a single entity that can satisfy the requirements of a particular buyer.

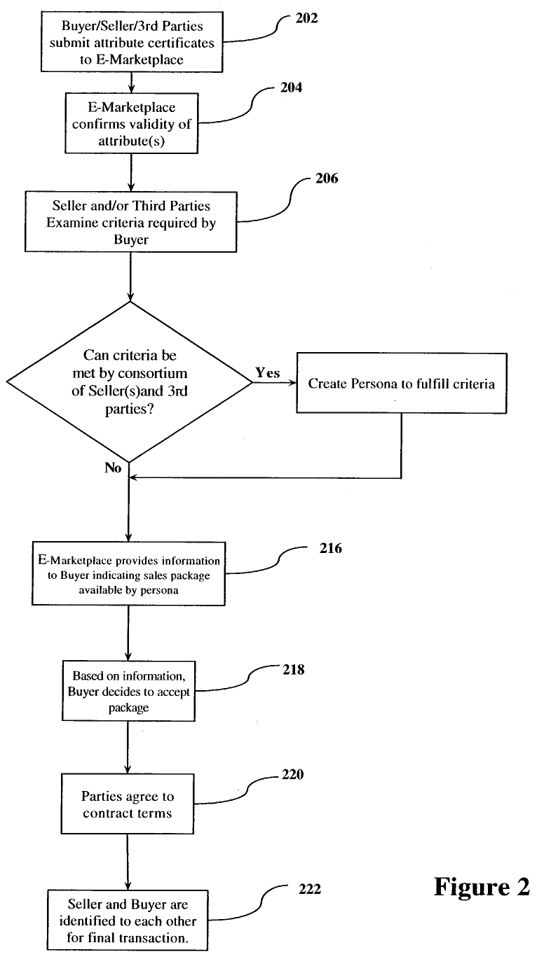

FIG. 2 is a flowchart illustrating the basic steps performed in accordance with the present invention. At step 202, a buyer and/or seller and/or third party participant submits an attribute certificate to the E-marketplace. This may involve completion of a form provided by E-marketplace which solicits specific information regarding a particular purchase or desires for purchase.

At step 204, the E-marketplace confirms the validity of any and all attributes submitted by the buyers and/or sellers and/or third party participants. If the E-marketplace determines that any of the attributes that were submitted are invalid, then they are omitted and not provided in response to inquiries about a particular transaction and/or a particular party. If, however, the attributes are valid, then they will be provided to users of the E-marketplace.

At step 206, sellers and/or third parties examine criteria required by buyers in the E-marketplace, as read from the attribute certificates submitted by the buyers. The sellers and third party participants also examine the attribute certificates submitted by each other to see if there are any potential consortiums that can be arranged to form a persona to meet the buyer's criteria. At step 208 a determination is made as to whether or not the criteria of the buyer can be met by a consortium of the sellers and third parties. If it can, then at step 210 a persona is created to fulfill the criteria and an attribute certificate, in the name of the persona, is submitted to the E-marketplace. At step 212, the E-marketplace provides information to a buyer indicating the existence of the persona that can meet its criteria. At step 214, based upon this information, the buyer decides to purchase from the persona. At step 216 the parties agree to contract terms, and at step 218, to the extent necessary to facilitate the sale, the seller and one or more members of the consortium are identified to each other to allow completion of the final transaction.

Using the present invention, all of the necessary information is summarized and available to all interested parties without having to know the identity of who is providing this information. In this manner, parties can band together to develop a persona which, when they are combined, are capable of supplying desired products or services in accordance with the needs of a particular customer.

Following is an example illustrating the use of attribute certificates in accordance with the present invention. Assume for this example that a Fortune 500 company called XYZ Corporation wishes to be able to purchase 10,000 units of widget A per month for a period of two years. Assume also that a smaller corporation, ABC, Inc. is able to produce 4,000 units of widget A per month, UVW Corporation can produce 7,000 units of widget A per month, and RST Corporation is willing to guarantee, with insurance, that together XYZ Corporation and UVW Corporation can supply 10,000 units of widget A per month for two years.

XYZ Corporation, seeing the needs of the ABC Corporation and the abilities of UVW Corporation and RST Corporation, proposes that the three of them form a consortium and identify same with a persona, called the RUX Company, and together they prepare a persona attribute certificate for the RUX Company and submit it to the E-marketplace.

From the perspective of the ABC Corporation, a company, RUX Company, is identified that can meet its needs. The E-marketplace has already verified that the information contained in the attribute certificate of RUX Company is accurate; thus, ABC Inc. can immediately agree to a deal with RUX Company and negotiate a final contract with them.

The present invention can be embodied in either hardware or software. In a preferred embodiment, the present invention is embodied in software code residing on the E-marketplace server(s) to carry out the described steps and functions.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as in the permanent storage of a workstation or server maintained by the E-Marketplace. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method of conducting an electronic commerce transaction having predefined satisfaction requirements set forth by a requesting party, comprising the steps of:
creating an attribute certificate for each prospective participant to said transaction;
submitting each of said attribute certificates to a third party;
validating each of said attribute certificates;
identifying, based on said validated attribute certificates, prospective participants and/or combinations of prospective participants who can satisfy said predefined satisfaction requirements;
designating each of said prospective participants and/or combinations of prospective participants who can satisfy said predefined satisfaction requirements as a distinct entity; and
conveying each of said entity designations to said requesting party.

2. A method as set forth in claim 1, wherein each of said attribute certificates contains only non-identity information pertaining to said transaction.

3. A method as set forth in claim 2, wherein said validation step is conducted by said third party.

4. A method as set forth in claim 3, wherein said non-identity information comprises one or more non-identity elements and wherein said validation step comprises at least the steps of:
checking the accuracy of each non-identity element; and
deleting from said attribute certificate those non-identity elements that are inaccurate.

5. A method as set forth in claim 3, wherein said non-identity information comprises one or more non-identity elements and wherein said validation step comprises at least the steps of:
checking the accuracy of each non-identity element; and
deleting any attribute certificate that contains an inaccurate non-identity element.

6. A method as set forth in claim 3, wherein said third party comprises an E-marketplace.

7. A system for conducting an electronic commerce transaction having predefined satisfaction requirements set forth by a requesting party, comprising:
means for creating an attribute certificate for each prospective participant to said transaction;
means for submitting each of said attribute certificates to a third party;
means for validating each of said attribute certificates;
means for identifying, based on said validated attribute certificates, prospective participants and/or combinations of prospective participants who can satisfy said predefined satisfaction requirements;
means for designating each of said prospective participants and/or combinations of prospective participants who can satisfy said predefined satisfaction requirements as a distinct entity; and
means for conveying each of said entity designations to said requesting party.

8. A system as set forth in claim 7, wherein each of said attribute certificates contains only non-identity information pertaining to said transaction.

9. A system as set forth in claim 8, wherein said validation means is used by said third party to validate each of said attribute certificates.

10. A system as set forth in claim 9, wherein said non-identity information comprises one or more non-identity elements and wherein said validation step comprises:
means for checking the accuracy of each non-identity element; and
means for deleting from said attribute certificate those non-identity elements that are inaccurate.

11. A system as set forth in claim 9, wherein said non-identity information comprises one or more non-identity elements and wherein said validation means comprises:
means for checking the accuracy of each non-identity element; and
means for deleting any attribute certificate that contains an inaccurate non-identity element.

12. A system as set forth in claim 9, wherein said third party comprises an E-marketplace.

13. A computer program product recorded on computer-readable storage medium, for conducting an electronic commerce transaction having predefined satisfaction requirements set forth by a requesting party, comprising:
computer-readable means for creating an attribute certificate for each prospective participant to said transaction;
computer-readable means for submitting each of said attribute certificates to a third party;
computer-readable means for validating each of said attribute certificates;
computer-readable means for identifying, based on said validated attribute certificates, prospective participants and/or combinations of prospective participants who can satisfy said predefined satisfaction requirements;
computer-readable means for designating each of said prospective participants and/or combinations of prospective participants who can satisfy said predefined satisfaction requirements as a distinct entity; and
computer-readable means for conveying each of said entity designations to said requesting party.

14. A computer program product as set forth in claim 13, wherein each of said attribute certificates contains only non-identity information pertaining to said transaction.

15. A computer program product as set forth in claim 14, wherein said computer-readable validation means is used by said third party to validate each of said attribute certificates.

16. A computer program product as set forth in claim 15, wherein said non-identity information comprises one or more non-identity elements and wherein said computer-readable validation means comprises:
computer-readable means for checking the accuracy of each non-identity element; and
computer-readable means for deleting from said attribute certificate those non-identity elements that are inaccurate.

17. A computer program product as set forth in claim 15, wherein said non-identity information comprises one or more non-identity elements and wherein said computer-readable validation means comprises:
computer-readable means for checking the accuracy of each non-identity element; and
computer-readable means for deleting any attribute certificate that contains an inaccurate non-identity element.

18. A computer program product as set forth in claim 15, wherein said third party comprises an E-marketplace.
